(19) United States
(12) Patent Application Publication
(10) Pub. No.: US 2015/0098234 A1
(43) Pub. Date: Apr. 9, 2015

(54) HEAT DISSIPATING APPARATUS FOR AUTOMOTIVE LAMP

(71) Applicant: SL Corporation, Daegu (KR)

(72) Inventor: Jang Hosung, Gyungsan (KR)

(73) Assignee: SL Corporation

(21) Appl. No.: 14/446,293

(22) Filed: Jul. 29, 2014

(30) Foreign Application Priority Data
Oct. 8, 2013 (KR) 10-2013-0119865

(51) Int. Cl. F21S 8/10; F21V 7/20

(52) U.S. Cl. CPC F21S 48/321; F21V 7/20
USPC 362/516

(57) ABSTRACT

A heat dissipating apparatus for a vehicle lamp is provided that simplifies the structure of a vehicle lamp using laser light and more effectively dissipates heat from the vehicle lamp. The heat dissipating apparatus includes a light source unit that is configured to generate laser light and a mirror that is configured to reflect the laser light and guide the laser light toward a lamp unit. The lamp unit is configured to emit light with a predetermined light distribution pattern. Further, a heat dissipation unit is disposed on one side of the mirror and is configured to dissipate heat from the mirror.

### CROSS-REFERENCE TO RELATED APPLICATION

This application claims priority to Korean Patent Application No. 10-2013-0119865 filed on Oct. 8, 2013, which application is incorporated herein by reference.

### BACKGROUND

1. Field of the Invention

The invention relates to an automotive lamp, and more particularly, to a heat dissipating apparatus for an automotive lamp, which simplifies the structure of an automotive lamp using laser light and more effectively dissipates heat from the automotive lamp.

2. Description of the Related Art

Many vehicles today are equipped with lamps for illuminating nearby objects during night-time driving (e.g., during poor lighting conditions) or signaling nearby vehicles or pedestrians as to a state of driving. For example, headlights and fog lights are mainly for illuminating purposes, and turn signal lights, taillights, brake lights, and side marker lights are mainly for signaling purposes. There are rules and regulations in place that state specification and installation criteria that automotive lamps should follow to properly perform their functions. In addition, light-emitting diodes (LEDs) or laser diodes have been used as light sources for automotive lamps, and research has been conducted regarding methods of using, as an excitation light source, light generated by exciting phosphors with light emitted from a light source. Laser light emitted from laser diodes generally has substantially high luminance and strong directivity and can thus be easily collected without loss. Accordingly, laser diodes provide light with substantially higher luminance and higher definition than LEDs.

However, the performance of laser diodes may vary depending on temperature. Accordingly, a heat dissipation structure may be provided in an automotive lamp using a laser diode, for preventing an increase in temperature that may be caused by heat generated from the automotive lamp. In theory, heat-generating elements of the automotive lamp, such as a laser diode and a mirror reflecting laser light generated by the laser diode, require separate heat dissipation structures for effective heat dissipation. However, the structure of the automotive lamp would become more complex and manufacturing costs may increase to provide each heat-generating element of an automotive lamp with a heat dissipation structure. Therefore, a method is needed to effectively dissipate heat from an automotive lamp using laser light, while simplifying the structure of the automotive lamp.

### SUMMARY

The present invention provides a heat dissipating apparatus for an automotive lamp (e.g., a vehicle lamp), in which a mirror reflecting laser light incident thereupon from a light source unit of an automotive lamp is provided with a heat dissipation unit to prevent the reflective properties or the shape of the mirror from changing due to heat from the incident laser light. In addition, the present invention provides a heat dissipating apparatus for an automotive lamp, in which a heat dissipation unit is provided for a mirror to prevent an increase in temperature that may be caused by heat from a light source unit or the mirror and is configured to extend from the mirror to the light source unit to be used for both the mirror and the light source unit. However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, a heat dissipating apparatus for an automotive lamp may include: a light source unit configured to generate laser light; a mirror configured to reflect the laser light and to guide the laser light toward a lamp unit, which emits light with a predetermined light distribution pattern; and a heat dissipation unit disposed on one side of the mirror and configured to dissipate heat from the mirror.

According to the exemplary embodiment, since a heat dissipation unit may be disposed at a mirror that receives laser light, it may be possible to prevent the reflective properties or the shape of the mirror from changing due to heat from the mirror and increase the lifespan of the mirror. In addition, since the heat dissipation unit may be formed to extend from the mirror to a light source unit, it may be possible to use the heat dissipation unit for both the mirror and the light source unit. Further, it may be possible to simplify the structure of a heat dissipating apparatus for an automotive lamp and more effectively dissipate heat, as compared to a case in which separate heat dissipation units are provided for the mirror and the light source unit. Other features and exemplary embodiments will be apparent from the following detailed description, the drawings, and the claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary diagram of a heat dissipating apparatus for an automotive lamp, according to an exemplary embodiment of the invention;

FIGS. 2 and 3 are exemplary diagrams of lamp units according to exemplary embodiments of the invention;

FIG. 4 is an exemplary diagram of a heat dissipating apparatus for an automotive lamp, according to another exemplary embodiment of the invention;

FIG. 5 is an exemplary diagram of a heat dissipating apparatus for an automotive lamp, according to another exemplary embodiment of the invention; and

FIG. 6 is an exemplary diagram of a heat dissipating apparatus for an automotive lamp including a plurality of light sources, according to another exemplary embodiment of the invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Advantages and features of the invention and methods of accomplishing the same may be understood more readily by reference to the following detailed description of exemplary embodiments and the accompanying drawings. The invention may, however, be embodied in many different provides and should not be construed as being limited to the exemplary embodiments set forth herein. Rather, these exemplary embodiments are provided so that this disclosure will be thorough and complete and will fully convey the concept of the invention to those skilled in the art, and the invention will only be defined by the appended claims. Like reference numerals refer to like elements throughout the specification.

The exemplary embodiments and features of the invention and methods for achieving the exemplary embodiments and features will be apparent by referring to the exemplary embodiments to be described in detail with reference to the accompanying drawings. However, the invention is not limited to the exemplary embodiments disclosed hereinafter, but can be implemented in diverse provides. The matters defined in the description, such as the detailed construction and elements, are nothing but specific details provided to assist those of ordinary skill in the art in a comprehensive understanding of the invention, and the invention is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the invention, the same drawing reference numerals are used for the same elements across various figures. Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

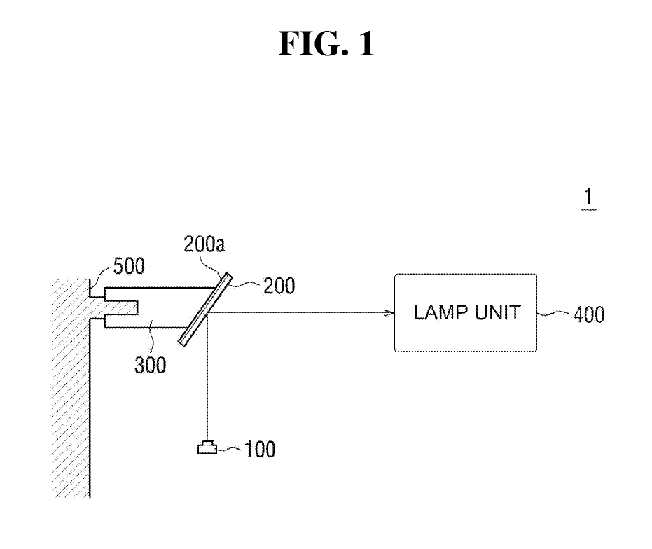

Exemplary embodiments will hereinafter be described with reference to the accompanying drawings. FIG. 1 is an exemplary diagram of a heat dissipating apparatus for an automotive lamp, according to an exemplary embodiment of the invention. Referring to FIG. 1, a heat dissipating apparatus 1 may include a light source unit 100, a mirror 200 and a heat dissipation unit 300.

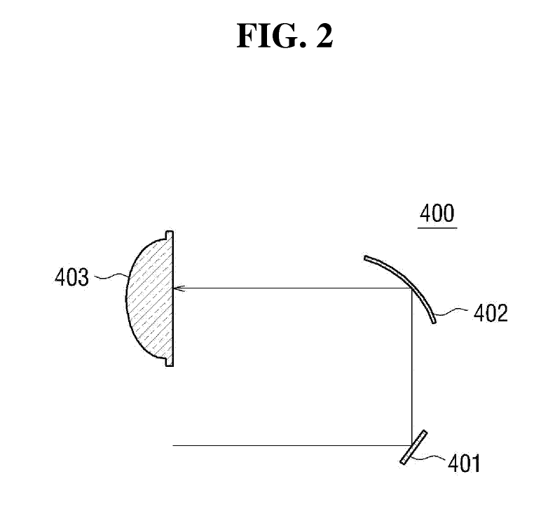

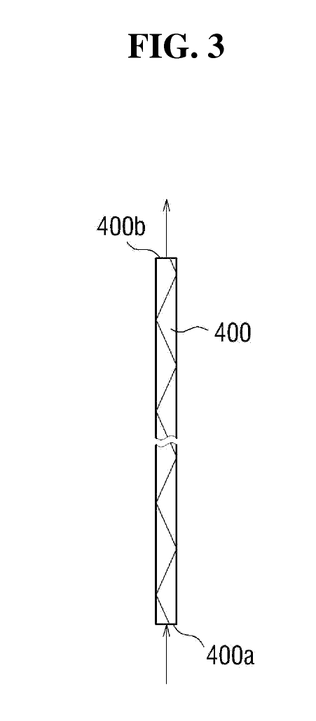

A laser diode, configured to generate laser light that may be used as excitation light, may be used as the light source unit 100. For example, a nitride semiconductor that generates laser light, ranging from ultraviolet (UV) light to blue light, may be used in the light source unit 100. In this exemplary embodiment, a laser diode may be used as the light source unit 100, but the invention is not limited thereto. In other words, various light sources other than a laser diode, such as a light-emitting diode (LED), may be used as, or employed in, the light source unit 100. The mirror 200 may be configured to reflect laser light generated by the light source unit 100 in one or more directions and may thus guide the laser light to a lamp unit 400, configured to emit light with a predetermined distribution pattern based on the laser light. The lamp unit 400 may be configured to emit various beams with different light distribution patterns depending on the purpose of the use of an automotive lamp. For example, automotive lamps include a headlight, a taillight, a brake light, a backup lamp, a turn signal light, a daytime running light, a fog light, and a position light, and the lamp unit 400 may be configured to emit various beams with different light distribution patterns for different types of automotive lamps. The structure of the lamp unit 400 will hereinafter be described with reference to FIGS. 2 and 3.

Referring to FIG. 2, the lamp unit 400 may include a phosphor 401, a reflector 402 and a lens 403. The phosphor 401 may be excited by laser light and may thus be configured to generate light of a predetermined color. In this exemplary embodiment, the phosphor 401 may be configured to generate white light that an automotive lamp is typically required to emit, but the invention is not limited thereto. In other words, the color of the light generated by the phosphor 401 may vary depending on the purpose of use of an automotive lamp. For example, in response to the light source unit 100 generating blue laser light with a peak wavelength range of about 440 nm to about 490 nm, a yellow phosphor with a peak wavelength range of about 560 nm to about 590 nm may be used as the phosphor 401 to cause the phosphor 401 to emit white light.

In this exemplary embodiment, the light source unit 100 may be configured to generate blue laser light and a yellow phosphor may be used as the phosphor 120. However, the invention is not limited to this exemplary embodiment. In other words, various phosphors, such as blue, green and red phosphors, or a combination thereof may be used as the phosphor 120. In this exemplary embodiment, the phosphor 401 may be a reflective phosphor that includes a reflective layer formed on one side of the phosphor 401 and may be configured to reflect light generated by excitation caused by laser light, but the invention is not limited thereto. In other words, a transmissive phosphor configured to transmit through light generated by excitation caused by laser light, may also be used as the phosphor 401, in which case, the locations of the reflector 402 and the lens 403 may differ from those illustrated in FIG. 2.

The reflector 402 may be configured to reflect light generated by the phosphor 401 to travel toward the lens 403. A reflective layer may be deposited on one surface of the reflector 402 upon which the light generated by the phosphor 401 is incident, and may be formed of a highly reflective material such as aluminum (Al), chromium (Cr) or a Cr alloy. The reflector 402 may be formed in a free curve shape or an elliptical surface shape. The lens 403 may allow light reflected from the reflector 402 to be emitted outward from a vehicle (not illustrated). Various aspherical lenses with different curvature properties may be used depending on the type of light distribution pattern needed.

In the example illustrated in FIG. 2, light generated by the phosphor 401 may be reflected by the reflector 402 and may travel (e.g., may be transmitted) toward the lens 403, but the invention is not limited thereto. In other words, the reflector 402 may be omitted, and light generated by the phosphor 401 may travel directly toward the lens 403. In the example illustrated in FIG. 2, the lamp unit 400 may include the phosphor 401, the reflector 402 and the lens 403, but the invention is not limited thereto. In other words, the lamp unit 400 may also include a shield (not illustrated), disposed between the reflector 402 and the lens 403 to block the transmission of light therebetween and to form a predetermined light distribution pattern.

Referring to FIG. 3, the lamp 400 may be a light guide member, such as a light guide or an optic fiber, configured to guide light incident upon a first side 400a thereof to emit therefrom through a second side 400b thereof. In the example illustrated in FIG. 3, the lamp unit 400 may be configured to perform the functions of a lamp, as described above with reference to FIG. 2, and also the functions of a light guide member for guiding laser light reflected from the mirror 200 toward the phosphor 401. In response to the lamp unit 400 being a light guide member configured to guide laser light reflected from the mirror 200 toward the phosphor 401, the degree of design freedom may be improved since location restrictions of the mirror 200 and the lamp unit 400 may be eliminated.

Referring back to FIG. 1, the heat dissipation unit 300 may be disposed on one side of the mirror 200, and may be configured to dissipate heat generated by the mirror 200 to prevent problems such as deteriorated reflective properties or shape deformation of the mirror 200. The heat dissipation unit 300 may be attached to one side of the mirror 200 using screws (e.g., any fastening mechanism), may be a snap-fit, or may be attached an adhesive. Due to laser light emitted from the light source unit 100 and incident upon the mirror 200, the mirror 200 may be configured to generated heat. A continued generation of heat may cause various problems to the mirror 200 such as deteriorated reflective properties or shape deformation. In this exemplary embodiment, the heat dissipation unit 300 may be provided to prevent the reflective properties or the shape of the mirror 200 from changing due to heat. The heat dissipation unit 300 may be formed of a material with relatively high conductivity such as magnesium (Mg) or Al, but the invention is not limited thereto. In other words, the heat dissipation unit 300 may be formed of various other materials with excellent thermal conductivity, such as a nonferrous metal material or a thermally conductive plastic material.

For an improved thermal conductivity, a thermal interface material 200a may be provided on the contact surface between the heat dissipation unit 300 and the mirror 200. The thermal interface material 200a may facilitate the transmission of heat generated by the mirror 200 to prevent any deterioration in the performance of the mirror 200, may create the contact surface between the heat dissipation unit 300 and the mirror even, and may absorb impact. A thermal pad, a thermal grease or a thermal tape may be used as the thermal interface material 200a. The thermal pad, which is an elastic member containing silicon-based polymers, may have a composite layer structure including a stack of a thermally conductive layer, which is formed of a soft resin containing thermally conductive metal-based powder, and a dielectric layer, which is formed of a soft resin containing inorganic powder or ceramic-based powder. The thermal grease may be a gel-type liquid-phase material that may be applied between the heat dissipation unit 300 and the mirror 200. The thermal tape may have a similar structure to that of the thermal pad, and may include a thermally conductive adhesive.

The heat dissipation unit 300 may be installed in, and fixed to, a lamp housing 500 before or after the installation of the mirror 200 in the lamp housing 500, and may be disposed a predetermined distance from the lamp housing 500 with the aid of, for example, screws. In this exemplary embodiment, the heat dissipation unit 300 may be the predetermined distance apart from the lamp housing 500 to form a passage for air circulation between the heat dissipation unit 300 and the lamp housing 500 and thus to more effectively dissipate heat, but the invention is not limited thereto. In other words, the heat dissipation unit 300 may be firmly attached to the lamp housing 500 when no air circulation problems are present or the lamp housing 500 may be formed of a thermally conductive material. In this exemplary embodiment, the heat dissipation unit 300 may be disposed on one side of the mirror 200, but the invention is not limited thereto. The heat dissipation unit 300 may be formed to connect the light source unit 100 and the mirror 200. In other words, the heat dissipation unit 300 may be formed to extend from one side of the mirror 200 to the light source unit 100.

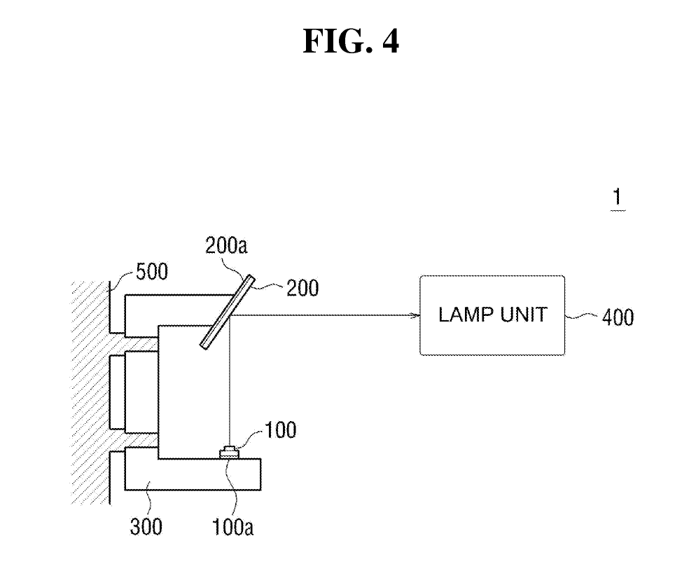

FIG. 4 is an exemplary diagram of a heat dissipating apparatus for an automotive lamp, according to another exemplary embodiment of the invention. Referring to FIG. 4, a heat dissipating apparatus 1, like its counterpart of the exemplary embodiment of FIG. 1, may include a light source unit 100, a mirror 200 and a heat dissipation unit 300. The light source unit 100, the mirror 200 and the heat dissipation unit 300 are similar to their respective counterparts of FIG. 1 in terms of their functions and materials, and thus, detailed descriptions thereof will be omitted. In this exemplary embodiment, unlike in the exemplary embodiment of FIG. 1, the heat dissipation unit 300 may be formed to connect the light source unit 100 and the mirror 200. In other words, the heat dissipation unit 300 may be formed to extend from one side of the mirror 200 to the light source unit 100. In this exemplary embodiment, the heat dissipation unit 300 may be formed in one piece, and the light source unit 100 and the mirror 200 may be installed at both ends, respectively, of the heat dissipation unit 300. Additionally, screws or a snap-fit, or an adhesive may be used to attach the light source unit 100 and the mirror 200 to the heat dissipation unit 300.

For an improved thermal conductivity, thermal interface materials 100a and 200a may be provided on the contact surfaces between the light source unit 100 and the heat dissipation unit 300 and between the heat dissipation unit 300 and the mirror 200, respectively. The thermal interface materials 100a and 200a are similar to the thermal interface material 200a of FIG. 1 in terms of their functions and types, and thus, detailed descriptions thereof will be omitted. In this exemplary embodiment, the light source unit 100 and the mirror 200 may both be provided with a thermal interface material, but the invention is not limited thereto. In other words, at least one of the light source unit 100 and the mirror 200 may be provided with a thermal interface material. In the description that follows, it may be assumed that a thermal interface material is provided on the surface of each element placed in contact with the heat dissipation unit 300, but the invention is not limited thereto. That is, no thermal interface material may be provided.

In this exemplary embodiment, the heat dissipation unit 300 may be installed in, and fixed to, a lamp housing 500 before or after the installation of the mirror 200 in the lamp housing 500, and may be disposed a predetermined distance from the lamp housing 500 with the aid of, for example, screws. The installation of the heat dissipation unit 300 in the lamp housing 500 has already been discussed above with reference to FIG. 1, and thus, a detailed description thereof will be omitted. In this exemplary embodiment, the heat dissipation unit 300 may be the predetermined distance apart from the lamp housing 500 to form a passage for air circulation between the heat dissipation unit 300 and the lamp housing 500 and thus to more effectively dissipate heat, but the invention is not limited thereto. The heat dissipation unit 300 may be firmly attached to the lamp housing 500 when no air circulation problems are present or the lamp housing 500 may be formed of a thermally conductive material. In this exemplary embodiment, the heat dissipation unit 300 may be formed in one piece, and the light source unit 100 and the mirror 200 may be installed at both ends, respectively, of the heat dissipation unit 300. However, the invention is not limited to this exemplary embodiment. That is, more than one heat dissipation unit 300 may be provided.

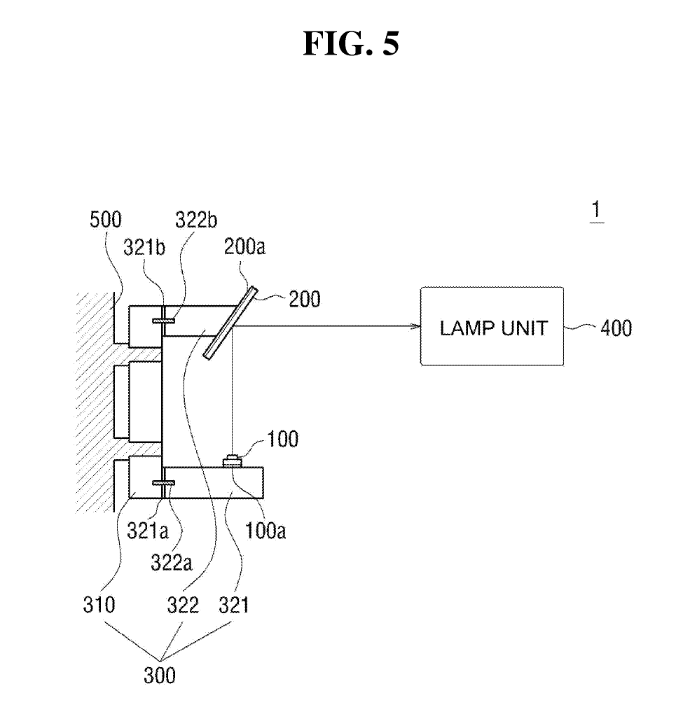

FIG. 5 is an exemplary diagram of a heat dissipating apparatus for an automotive lamp, according to another exemplary embodiment of the invention. Referring to FIG. 5, a heat dissipating apparatus 1, like its counterpart of the exemplary embodiment of FIG. 1 or 4, may include a light source unit 100, a mirror 200 and a heat dissipation unit 300. The light source unit 100, the mirror 200 and the heat dissipation unit 300 are similar to their respective counterparts of FIG. 1 or 4 in terms of their functions and materials, and thus, detailed descriptions thereof will be omitted.

The heat dissipation unit 300 may include a first heat dissipation portion 310 and a plurality of second heat dissipation portions 321 and 322, may be are coupled to both ends, respectively, of the first heat dissipation portion 310. The first heat dissipation portion 310, like the heat dissipation unit 300 of FIG. 1, may be installed within a lamp housing 500. The first heat dissipation portion 310 may be configured to support the heat dissipation unit 300. The second heat dissipation portions 321 and 322, which may be coupled to both ends, respectively, of the first heat dissipation portion 310, may be configured to transmit heat generated by the light source unit 100 and the mirror 200.

The first heat dissipation portion 310 and the second heat dissipation portions 321 and 322 may be coupled together by thermally conductive assembly members 321a and 322a, for example, screws formed of a material with excellent thermal conductivity. Thermal interface materials 321b and 322b, which are similar to the thermal interface material 200a of FIG. 1, may be provided on the contact surfaces between the first heat dissipation portion 310 and the second heat dissipation portion 321 and between the first heat dissipation portion 310 and the second heat dissipation portion 322, respectively. Thermal interface materials 100a and 200a, which are similar to the thermal interface material 200a of FIG. 1, may be provided on the contact surfaces between the light source unit 100 and the second heat dissipation portion 321 and between the second heat dissipation portion 322 and the mirror 200, respectively.

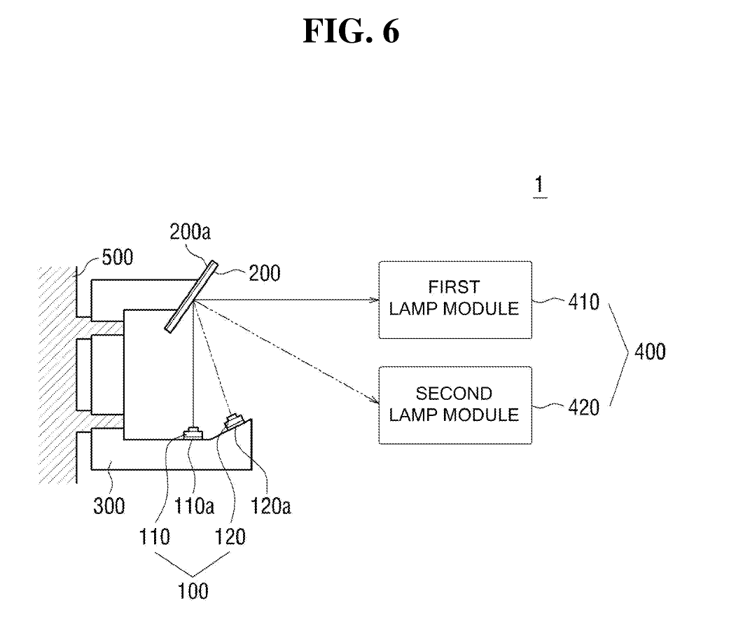

In the exemplary embodiments of FIGS. 1, 4 and 5, the mirror 200 may be configured to reflect laser light in one direction, but the invention is not limited thereto. In other words, a plurality of light sources may be provided, in which case, in response to the receipt of laser beams with different incidence angles from the light sources, the mirror 200 may be configured to reflect the laser beams in a plurality of directions. More specifically, referring to FIG. 6, a light source unit 100 may include a first light source 110 and a second light source 120, and the first light source 110 and the second light source 120 may be arranged to emit laser beams that are to be incident upon the reflective surface of a mirror 200 at different incidence angles. Accordingly, the mirror 200 may be configured to reflect laser light from the first light source 110 and laser light from the second light source 120 in different directions. A lamp unit 400, unlike the lamp unit 400 of FIG. 4, may include a first lamp module 410 and a second lamp module 420. Since laser beams incident upon the mirror 200 at different angles may be reflected from the mirror 200 at different angles, the mirror 200 may be configured to reflect laser light from the first light source 110 and laser light from the second light source 120 to travel toward the first lamp module 410 and the second lamp module 420, respectively. The first lamp module 410 and the second lamp module 420 may have a similar structure to that of the lamp unit 400 of FIG. 1.

The heat dissipation unit 300 may be provided with a plurality of contact surfaces in an area where the light source unit 100 is disposed, and the contact surfaces may be configured to have different inclination angles with respect to the surface of the ground in consideration of the incidence angle of light from the first light source 110 and the incidence angle of laser light from the second light source 120. Accordingly, the heat dissipation unit 300 may be configured to more effectively dissipate heat even from a plurality of light sources, i.e., the first light source 110 and the second light source 120.

In this exemplary embodiment, the first light source 110 may be disposed on the contact surface of the heat dissipation unit 300 that is parallel to the surface of the ground, and the second light source 120 may be provided on the contact surface of the heat dissipation unit 300 that is diagonal with respect to the surface of the ground. However, the invention is not limited to this exemplary embodiment. In other words, the angles of the contact surfaces between the heat dissipation unit 300 and the first light source 110 and between the heat dissipation unit 300 and the second light source 120 with respect to the surface of the ground may be set to vary depending on the incidence angle of light from the first light source 110 and the incidence angle of laser light from the second light source 120. Thermal interface materials 110a and 120a, which are similar to the thermal interface material 200a of FIG. 1, may be provided on the contact surfaces between the heat dissipation unit 300 and the first light source 110 and between the heat dissipation unit 300 and the second light source 120, respectively.

This exemplary embodiment is applicable to the heat dissipation unit 300 of FIG. 4, but the invention is not limited thereto. The exemplary embodiment is also applicable to the heat dissipation unit 300 of FIG. 5. When this exemplary embodiment is applied to the heat dissipation unit 300 of FIG. 5, the second heat dissipation portion 321 where the light source unit 100 is installed may be provided with a plurality of contact surfaces having different inclination angles with respect to the surface of the ground, as illustrated in FIG. 6.

According to the exemplary embodiments of FIGS. 1 and 4 to 6, an increase in temperature that may be caused by heat generated by the light source unit 100 and/or the mirror 200 may be prevented. In particular, when the heat dissipation unit 300 is formed to connect the light source unit 100 and the mirror 200, the heat dissipation unit 300 may be used for both the light source unit 100 and the mirror 200. As a result, the structure of the heat dissipating apparatus 1 may be simplified, and the heat dissipation efficiency of the heat dissipating apparatus 1 may be improved compared to a case in which separate heat dissipating apparatuses 300 are provided for the light source unit 100 and the mirror 200.

While the invention has been particularly shown and described with reference to exemplary embodiments thereof, it will be understood by those of ordinary skill in the art that various changes in provide and detail may be made therein without departing from the spirit and scope of the invention as defined by the following claims. The exemplary embodiments should be considered in a descriptive sense only and not for purposes of limitation.

What is claimed is:

1. A heat dissipating apparatus for a vehicle lamp, comprising:
a light source unit configured to generate laser light;
a mirror configured to reflect the laser light and guide the laser light toward a lamp unit configured to emit light with a predetermined light distribution pattern; and
a heat dissipation unit disposed on one side of the mirror and configured to dissipate heat from the mirror.

2. The heat dissipating apparatus of claim 1, wherein a thermal interface material is provided on a contact surface between the mirror and the heat dissipation unit.

3. The heat dissipating apparatus of claim 1, wherein the heat dissipation unit is disposed a predetermined distance apart from a lamp housing.

4. The heat dissipating apparatus of claim 1, wherein the heat dissipation unit includes a nonferrous metal or a thermally conductive plastic material.

5. The heat dissipating apparatus of claim 1, wherein the heat dissipation unit is configured to connect the light source unit and the mirror.

6. The heat dissipating apparatus of claim 5, wherein the light source unit and the mirror are installed at both ends, respectively, of the heat dissipation unit and a thermal interface material is provided on at least one of contact surfaces between the heat dissipation unit and the light source unit and between the heat dissipation unit and the mirror.

7. The heat dissipating apparatus of claim 5, wherein the heat dissipation unit is configured to be formed in one piece.

8. The heat dissipating apparatus of claim 5, wherein the heat dissipation unit includes:
a first heat dissipation portion installed at a lamp housing; and
a plurality of second heat dissipation portions connected to the first heat dissipation portion,
wherein the light source unit and the mirror are installed at first sides of the second heat dissipation portions, respectively.

9. The heat dissipating apparatus of claim 8, wherein a thermal interface material is provided on contact surfaces between the first heat dissipation portion and the second heat dissipation portions, respectively.

10. The heat dissipating apparatus of claim 8, wherein the second heat dissipation portions are coupled to the first heat dissipation portion by a thermally conductive coupling member.

11. The heat dissipating apparatus of claim 5, wherein the light source unit includes:
a first light source and a second light source configured to generate laser beams to be incident upon the mirror at different incidence angles,
wherein the heat dissipation unit includes a plurality of contact surfaces that are contacted by the first and second light sources, respectively, the contact surfaces having different inclination angles according to the incidence angles of the laser beams from the first and second light sources.
